(19) United States
(12) Patent Application Publication
(10) Pub. No.: US 2026/0065730 A1
(43) Pub. Date: Mar. 5, 2026

(54) MONITORING SYSTEM, SALES DATA PROCESSING DEVICE, AND SALES DATA PROCESSING METHOD

(71) Applicant: Toshiba Tec Kabushiki Kaisha, Tokyo (JP)

(72) Inventors: Yuishi TAKENO, Numazu Shizuoka (JP); Tomonari KAKINO, Fuji Shizuoka (JP)

(21) Appl. No.: 19/219,872

(22) Filed: May 27, 2025

(30) Foreign Application Priority Data
Aug. 27, 2024 (JP) 2024-145732

(51) Int. Cl. G07C 9/10; G06Q 20/20; G06V 20/52; G07C 9/30; H04N 7/18

(52) U.S. Cl. CPC G07C 9/10; G06Q 20/208; G06Q 20/209; G06V 20/52; G07C 9/30; H04N 7/18

(57) ABSTRACT

According to one embodiment, a monitoring system includes an exit gate and a sales data processing device that does checkout processing for merchandise items in a sales transaction and generates a transaction receipt that can be read at the exit gate. A processor acquires an identifier from the transaction receipt at the exit gate, receives an image of a lower tier of a shopping cart at the exit gate and identifies whether an object is on the lower tier. The processor determines whether a merchandise item corresponding to the object on the lower tier was registered in the sales transaction associated with the acquired identifier and opens the exit gate when the object on the lower tier corresponds to a merchandise item included in the sales transaction but otherwise keeps the exit gate closed when the object is identified as being on the lower tier.

### CROSS-REFERENCE TO RELATED APPLICATION

This application is based upon and claims the benefit of priority from Japanese Patent Application No. 2024-145732, filed Aug. 27, 2024, the entire contents of which are incorporated herein by reference.

### FIELD

Embodiments described herein relate generally to a monitoring system, a sales data processing device, and a sales data processing method for retail stores or the like.

### BACKGROUND

In the related art, there are stores at which an exit gate system is installed. In this context, an exit gate system may include a door that can open and close and a drive unit that causes the door to open and close and is coupled to a reading unit that can be used to read a customer's receipt, or the like, to permit exit. The exit gate system opens the door and allows a customer to pass when the receipt read by the reading unit is valid.

This related-art exit gate system determines the validity of a receipt based on the date and time of the transaction on the receipt and whether the receipt has already been read at the exit gate (that is, whether the receipt is a previously used receipt). Therefore, the exit gate system is not generally concerned with whether the customer takes any merchandise out of the store without payment.

For example, in some cases, a customer may be using a shopping cart, but store staff operating a standard POS terminal usually cannot easily see the lower tier of the shopping cart due to an obstructed the view caused by the present of a checkout counter or table. Therefore, issues such as failure to register and settle a merchandise item put on the lower tier of the shopping cart may occur with these systems.

With a self-service checkout device that a customer uses for processing of the registration and settlement of merchandise, issues such as a failure to register a merchandise item may occur by mistake or intentionally. A monitoring camera in the store may be used to capture and limit such issues, but conventional cameras may still not be able to easily detect or see a merchandise item on the lower tier of a shopping cart.

As such, a customer may end up taking out unregistered or unpaid merchandise items from the store. Typically, a large-sized or heavy merchandise tends to be put on the lower tier of the shopping cart and often the price of such merchandise items tends to be higher than that of smaller items. Therefore, if the above trouble with items on the lower tier of a shopping carts can be detected in advance, a large loss to the store can be avoided.

### BRIEF DESCRIPTION OF THE DRAWINGS

FIG. 1 is a block diagram showing an example of the configuration of a store system.

FIG. 2 shows an example of the external appearance of an exit gate in a first embodiment.

FIG. 3 is a block diagram of a store server.

FIG. 4 is a block diagram of a POS terminal.

FIG. 5 is a block diagram of an exit gate.

FIG. 6 depicts processing units and interactions therebetween in a store system of an embodiment.

FIG. 7 is a flowchart of processing in a store system of an embodiment.

FIG. 8 illustrates aspects related to monitoring of a lower tier of a shopping cart at a full-self-service terminal in a second embodiment.

### DETAILED DESCRIPTION

Embodiments described herein concern monitoring systems, sales data processing devices, and a sales data processing methods that can be adopted as technological solutions to address problems in existing systems, devices, and methods related to potential losses associated with unregistered merchandise items on the lower tier of a shopping cart leaving a store without payment (settlement).

In general, according to one embodiment, a monitoring system includes an exit gate configured to open and close, a sales data processing device configured to perform checkout processing of merchandise items in a sales transaction of a customer and generate a transaction receipt for the customer that can be read at the exit gate for exiting, and a processor. The processor is configured to: acquire an identifier read from the transaction receipt at the exit gate; receive an image of a lower tier of a shopping cart at the exit gate and identify whether an object is on the lower tier; determine whether a merchandise item corresponding to the object on the lower tier was included in a sales transaction associated with the acquired identifier when the object is identified as being on the lower tier; and open the exit gate when it is determined that the object on the lower tier corresponds to a merchandise item included in the sales transaction associated with the acquired identifier, and otherwise keep the exit gate closed when the object is on the lower tier.

### First Embodiment

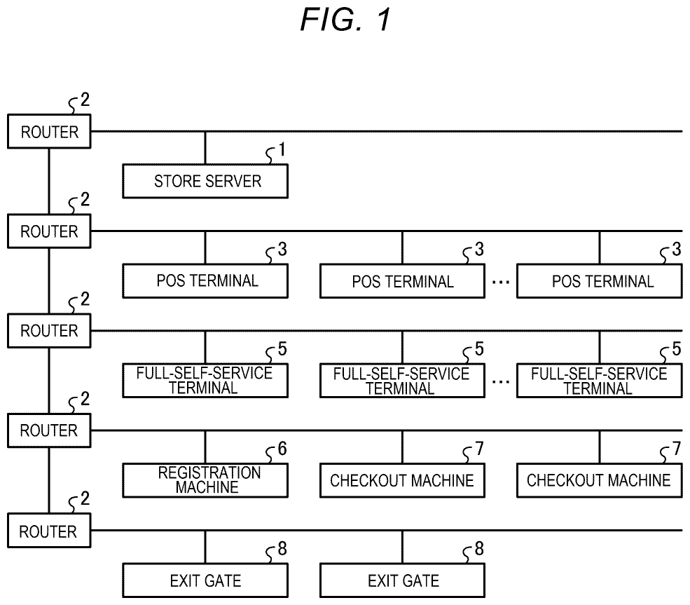

FIG. 1 is a block diagram showing an example of the configuration of a system provided in a store in one embodiment. In this example, the store has a system for performing sales data processing. This system may be referred to as a “store system” or the like and includes a store server 1, at least one router 2, at least one POS terminal 3, at least one full-self-service terminal 5, at least one registration machine 6, at least one checkout machine 7, and at least one exit gate 8.

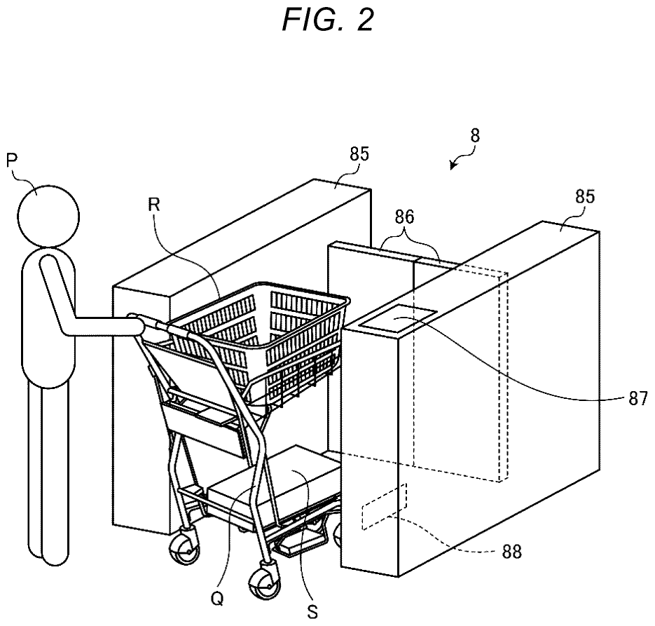

FIG. 2 shows an example of the external appearance of the exit gate 8 in the first embodiment. In FIG. 2, a customer P, a shopping cart Q, a shopping basket R, and an object S placed on the lower tier of the shopping cart Q are shown.

The exit gate 8 is installed, for example, near the main entrance/exit of the store. The exit gate 8 includes a pair of sides 85, a door 86, a code reader 87, an image pickup unit 88, and the like. The pair of sides 85 form a passageway for the customer to exit the store. The door 86 can block the passageway between the pair of sides 85. The door 86 can be opened and closed in an automated manner in response to predetermined processing or operation of the exit gate 8.

When an object S is present on the lower tier of the shopping cart Q, this may indicate a likelihood that the object S is a merchandise item yet to be paid for by the customer, so the monitoring system provides a notification or alert to indicate an object S is present on the lower tier of the shopping cart Q.

Here, the monitoring system acquires information about the lower tier of the shopping cart Q via the image pickup unit 88 installed in the exit gate 8. The monitoring system in this example also acquires information about items purchased by the customer P based on an identifier (ID) on the receipt read by the code reader 87 at the exit gate 8 for exit permission.

The store server 1 is, for example, an information processing device installed in the back office of the store, and collects and stores various kinds of information about the store such as information about merchandise items available at the store and information about the sales at the store.

In some examples, store server 1 may be installed at a head office that collectively manages the group to which the store belongs, and may store information about a plurality of stores. The type of the store in the present embodiment is a retail store but is not limited thereto. Also, while the store server 1 in the present embodiment is generally described as a single device, in practice the store server 1 may be implemented by the collaboration of a plurality of devices or the store server 1 may be a cloud server (or cloud system) implemented by a device connected to a network.

The router 2 connects the various system devices (store server 1, POS terminal 3, full-self-service terminal 5, registration machine 6, checkout machine 7, exit gate 8) to a network such as a local area network (LAN) provided in the store. Thus, these devices can communicate with each other. The term “POS” is an abbreviation of “point of sale” and refers to the “time and place at which a retail transaction takes place”.

The POS terminal 3, the full-self-service terminal 5, the registration machine 6, and the checkout machine 7 are each sales data processing devices. The POS terminal 3 is a device that executes processing for merchandise registration and checkout, mainly in response to an operation by store staff. The full-self-service terminal 5 is a device that executes processing for merchandise registration and checkout, mainly in response to an operation by a customer. The registration machine 6 is a device that executes processing for merchandise registration, mainly in response to an operation by store staff. The checkout machine 7 is a device that executes processing for checkout (payment), mainly in response to an operation by a customer.

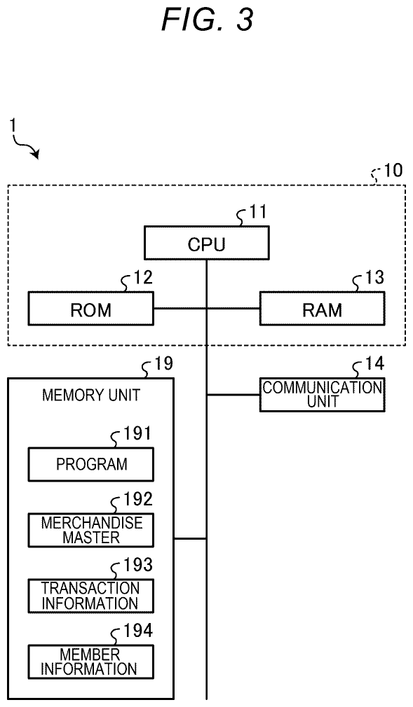

FIG. 3 is a block diagram showing an example of the configuration of the store server 1. The store server 1 includes a central processing unit (CPU) 11, a read-only memory (ROM) 12, a random-access memory (RAM) 13, a communication unit 14, a memory unit 19, and the like.

The communication unit 14 is a wired or wireless communication interface that can connect to a network such as a LAN. The communication unit 14 communicates with the various sales data processing devices via the network.

The CPU 11 is an example of a processor and manages and controls operations of the store server 1. The ROM 12 stores various programs. The RAM 13 is a work space where programs and various data are loaded.

The CPU 11, the ROM 12, and the RAM 13 are coupled together via a bus or the like and thus form a control unit 10 with a computer configuration. In the control unit 10, the CPU 11 operates according to a program stored in the ROM 12 or the memory unit 19 and loaded in the RAM 13 and thus executes various kinds of processing.

The memory unit 19 is configured with a non-volatile memory medium such as a hard disk drive (HDD) or a flash memory and maintains the stored contents even if the power is cut off. The memory unit 19 stores a program 191 that can be executed by the CPU 11 and various kinds of setting information. For example, the program 191 includes a program for implementing a functional configuration that is described later.

The memory unit 19 stores a merchandise master 192 in which information about merchandise items available at the store (merchandise information) is put together, transaction information 193, member information 194, and the like.

These pieces of information are an example. The memory unit 19 may also store other information. The various kinds of information stored in the memory unit 19 may be acquired in advance from another external device via a network or may be automatically acquired and updated.

Hereinafter, the merchandise master 192 and the transaction information may also be referred to as “POS data”. In other words, the “POS data” in the description below is, for example, the merchandise master 192 and the transaction information 193 but is not necessarily limited thereto.

### Merchandise Master

The merchandise master 192 is a collection of information about merchandise items available at the store and is stored, for example, in a data table format in the memory unit 19. The fields included in the data table as the merchandise master 192 can be as follows: merchandise code; merchandise name; unit price; collation data; and category.

The merchandise code is information (identification information) that enables unique identification of a merchandise and is, for example, a Japanese article number (JAN) code. The other information (merchandise name, unit price, collation data, category, and the like) is stored in association with the merchandise code. The information stored in the field of “merchandise name” can be the common name of the merchandise item. The information stored in the field of “unit price” is the price of one of the merchandise item.

The information stored in the field of “collation data” is reference feature data that can be used to identify the item from its appearance, size, or the like. Each device that executes sales data processing compares feature data from an image (picked-up image) of a merchandise item from a camera, image pickup unit, or the like to the reference collation data to acquire the merchandise code associated with the matching reference collation data, and thus can recognize the merchandise item in a picked-up image. To determine a match, the degree of similarity between the feature data in the picked-up image and collation data is calculated, the calculated degree of similarity is compared with a threshold, and the collation data with the degree of similarity equal to or higher than the threshold is identified as matching. In some examples, the merchandise code may be acquired by reading (scanning and decoding) a code symbol, such as a barcode or a two-dimensional code, attached to the merchandise item.

The information stored in the “category” field for each merchandise code is, for example, indicates a broad type of product packaging or visual appearance of the merchandise item that can be clearly recognized from the external appearance of the corresponding item. For example, the “category” values may be such things as “contained in a cardboard box”, “rice bag”, or “a pack of multiple tissue boxes”.

### Transaction Information

The transaction information 193 is information about merchandise items purchased (registered) by a customer and is received from the sales data processing device in the store and collected and stored. The transaction information 193 may include not only information from the present store but also transaction information received from a sales data processing device in another store.

The transaction information 193 is put together, for example, in a data table format. The fields included in the transaction information 193 are as follows: store ID; terminal ID; transaction ID; date and time; member ID; details information; and transaction amount.

In the field of “store ID”, a store ID of the store where the transaction of the record in question was carried out is stored. In the field of “terminal ID”, the terminal ID of the sales data processing device at which the transaction of the record in question was carried out is stored. The terminal ID is the identification information of a sales data processing device and is allocated in a way that avoids duplication of the same terminal ID at least within the same store.

The transaction ID is the identification information for a transaction and is automatically assigned (allocated), for example, at the time of the first merchandise registration processing for the transaction in question. In the field of “date and time”, the date and time when the transaction was carried out is stored.

In the field of “member ID”, a member ID can be stored if the customer carrying out the transaction presents a member ID. The member ID is the identification information of a customer who has registered as a member of customer loyalty scheme or the like, and is, for example, a unique number allocated on a per member basis.

The information stored in the field of “transaction amount” is the total amount (sum) of the prices of all the merchandise items purchased in the transaction of the record.

While one transaction amount is associated with a combination of a store ID, a terminal ID, and a transaction ID, the details information is not limited to one piece and a plurality of pieces of details information may be associated with the combination. The details information includes, for example, the following fields. Details Information: merchandise code; merchandise name; unit price; quantity; and price.

The merchandise code, the merchandise name, and the unit price are as already described above. The information stored in the field of “quantity” is the quantity (number of items, weight, volume or the like) of the merchandise item indicated by the merchandise code purchased in the transaction of the record. The information stored in the field of “price” is the value of the unit price multiplied by the quantity.

### Member Information

The member information 194 is information about a customer who is a member, and is stored, for example, in a data table format in the memory unit 19. The fields included in the data table as the member information 194 are, for example, as follows: member ID; name; and contact details.

The member ID is the identification information of a member. The member ID is, for example, a unique number allocated on a per member basis and is not duplicated in the system. Other relevant information (name, points owned, points transferred or the like) can be stored in association with the member ID. The information stored in the field of “name” is the name of a member. The information stored in the field of “contact details” is, for example, the address, telephone number, email address or the like of the member.

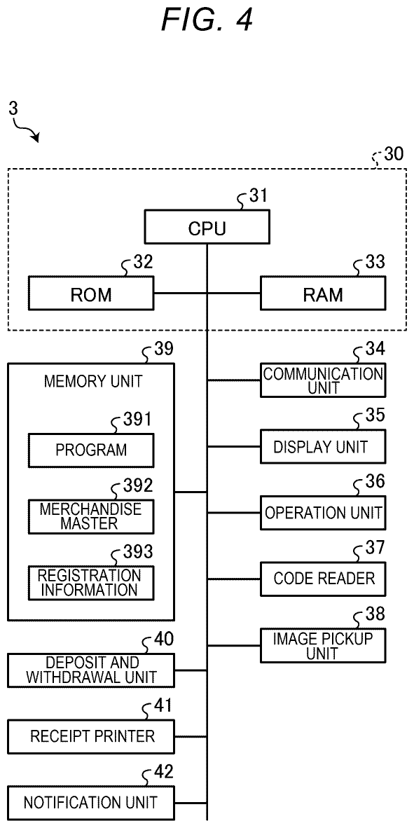

FIG. 4 is a block diagram showing an example of the configuration of the POS terminal 3. The POS terminal 3 includes a CPU 31, a ROM 32, a RAM 33, a communication unit 34, a display unit 35, an operation unit 36, a code reader 37, an image pickup unit 38, a memory unit 39, a deposit and withdrawal unit 40, a receipt printer 41, a notification unit 42, and the like.

The communication unit 34 is a wired or wireless communication interface that can connect to a network such as a LAN. The communication unit 34 communicates with another device connected via the network.

The display unit 35 can include a display device such as a liquid crystal display (LCD) and displays various kinds of information under the control of the CPU 31.

The operation unit 36 can include an input device such as a touch panel provided as superimposed on the display surface of the display unit 35, a keyboard, or a pointing device, and outputs an operation content input via the input device to the CPU 31.

The code reader 37 is, for example, a code reader or an image sensor and reads (decodes) a code symbol such as a barcode or a two-dimensional code. The code reader 37 may be a handheld scanner, a stationary-type code reader, or the like. The code reader 37 reads, for example, a code symbol in which information including a merchandise code is encoded, and thus acquires the merchandise code.

The image pickup unit 38 includes an image sensor or the like and acquires image data (picked-up image data) of an object (for example, a merchandise item).

The deposit and withdrawal unit 40 includes, for example, a built-in coin deposit and withdrawal device and a built-in bill deposit withdrawal device, and accepts payment (settlement) by cash. The deposit and withdrawal unit 40 may also be able to accept cashless settlement such as settlement by credit card, settlement by electronic money, and settlement by code based on the transmission and reception of information via a code symbol displayed on a smart device.

The receipt printer 41 dispenses (outputs) a paper (receipt) with transaction details printed thereon, upon completion of the settlement for the transaction. On the receipt, a code symbol in which an ID of the receipt (receipt ID) is encoded is printed along with the transaction details. In this example embodiment, the receipt ID is the same as the transaction ID. Each of the receipt ID and the code symbol in which the receipt ID is encoded is an example of an identifier.

The notification unit 42 is a device that outputs a sound, such as a buzzer or a speaker, or a device that emits light, such as a light-emitting diode (LED), and operates under the control of the CPU 31.

The CPU 31 is an example of a processor and manages and controls operations of the POS terminal 3. The ROM 32 stores various programs. The RAM 33 is a work space where programs and various data are loaded.

The CPU 31, the ROM 32, and the RAM 33 are coupled together via a bus or the like and thus form a control unit 30 with a computer configuration. As the CPU 31 operates according to a program stored in the ROM 32 or the memory unit 39 and loaded in the RAM 33, the control unit 30 functions as various functional units and executes various kinds of processing.

The memory unit 39 includes a memory medium such as an HDD or a flash memory and maintains the stored contents even if the power is cut off. The memory unit 39 stores a program 391 that can be executed by the CPU 31 and various kinds of setting information. For example, the program 391 includes a program for implementing a function that is described later.

The memory unit 39 stores a merchandise master 392, registration information 393, and the like. These pieces of information are an example. The memory unit 39 may also store other information.

The merchandise master 392 stores information conforming to the merchandise master 192. The merchandise master 392 may be periodically and automatically acquired and updated from a higher-level device via a network or the like.

The registration information 393 is information serving as a basis for the transaction information 193 and has a data configuration in a format conforming to the transaction information 193.

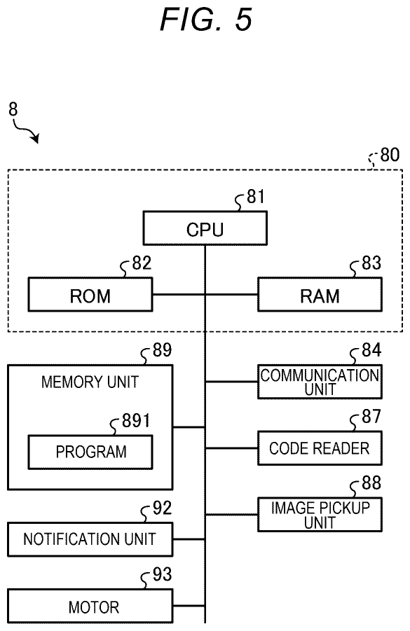

FIG. 5 is a block diagram showing an example of the configuration of the exit gate 8. The exit gate 8 includes a CPU 81, a ROM 82, a RAM 83, a communication unit 84, the code reader 87, the image pickup unit 88, a memory unit 89, a notification unit 92, a motor 93, and the like. The descriptions of the CPU 81, the ROM 82, the RAM 83, the communication unit 84, the image pickup unit 88, and the notification unit 92 correspond to those of the CPU 31, the ROM 32, the RAM 33, the communication unit 34, the image pickup unit 38, and the notification unit 42.

The memory unit 89 includes a memory medium such as an HDD or a flash memory and maintains the stored contents even if the power is cut off. The memory unit 89 stores a program 891 that can be executed by the CPU 81 and various kinds of setting information. For example, the program 891 includes a program for implementing a function that is described later.

The code reader 87 is, for example, a code reader or an image sensor and reads (decodes) a code symbol such as a barcode or a two-dimensional code. The code reader 87 can be mounted in one the sides 85. The code reader 87 reads a code symbol printed on a receipt and thus acquires the receipt ID.

The image pickup unit 88 is, for example, an image sensor or camera, with an imaging field of a predetermined range and outputs digital data (picked-up image data) that can be used to reproduce (display) the acquired image on a display device or the like.

The motor 93 is for opening and closing the door 86 under the control of the CPU 81.

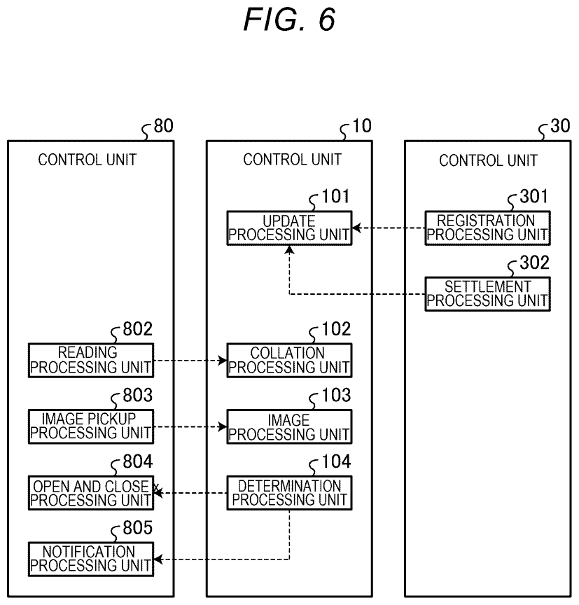

FIG. 6 is a block diagram showing an example of processing units provided by the control units 10, 30, 80 and the relationship and interactions between these processing units. As the CPU 11 executes the program 191, the control unit 10 functions as an update processing unit 101, a collation processing unit 102, an image processing unit 103, and a determination processing unit 104. As the CPU 31 executes the program 391, the control unit 30 functions as a registration processing unit 301 and a settlement processing unit 302. As the CPU 81 executes the program 891, the control unit 80 functions as a reading processing unit 802, an image pickup processing unit 803, an open and close processing unit 804, and a notification processing unit 805.

The registration processing unit 301 executes registration processing in response to an operation by the operator of the POS terminal 3 (generally store staff). More specifically, the registration processing unit 301 acquires a merchandise code via the operation unit 36 and the code reader 37. Alternatively, the registration processing unit 301 calculates feature data of a merchandise item from an image of the merchandise item based on picked-up image data from the image pickup unit 38 and compares the feature data with the collation data in the merchandise master 392 to acquire a merchandise code. Next, the registration processing unit 301 acquires the merchandise information corresponding to the acquired merchandise code from the merchandise master 392. The registration processing unit 301 then stores (registers) the acquired merchandise information as the registration information 393 in the memory unit 39.

The settlement processing unit 302 executes settlement processing in response to an operation by the operator of the POS terminal 3. For example, the settlement processing unit 302 accepts a deposit of money to the deposit and withdrawal unit 40 and causes the deposit and withdrawal unit 40 to discharge bills and coins as change. The settlement processing unit 302 also causes the receipt printer 41 to dispense a receipt.

Upon receiving the merchandise information registered by the registration processing unit 301, the update processing unit 101 stores the merchandise information as the transaction information 193 in the memory unit 19. Also, upon receiving information about the transaction settled by the settlement processing unit 302, the update processing unit 101 updates the transaction information 193.

The reading processing unit 802 is an example of an acquisition unit that acquires the identifier of a receipt. The reading processing unit 802 decodes a code symbol from the code reader 87, thus acquires the receipt ID (here directly corresponding to the transaction ID), and transmits the receipt ID to the store server 1. The image pickup processing unit 803 transmits picked-up image data from the image pickup unit 88 to the store server 1.

The open and close processing unit 804 controls the motor 93 to open and close the door 86 in response to an output from the determination processing unit 104.

If the object S regarded as being placed on the lower tier of the shopping cart Q is not included in the details information corresponding to the receipt ID, the notification processing unit 805 executes processing for giving a notification to that effect by output of visual information or audio information. More specifically, the notification processing unit 805 suitably causes the notification unit 92 to operate in response to an output from the determination processing unit 104.

The collation processing unit 102 acquires, from the memory unit 19, the transaction information 193 stored in correlation with the transaction ID that matches the receipt ID received from the exit gate 8. The association processing unit 102 also determines whether the acquired transaction information 193 is valid as transaction information of a customer who is about to exit the store. For example, in this determination, the collation processing unit 102 determines that the receipt is valid for exit if the time elapsed from the date and time in the transaction information 193 to the current date and time is less than or equal to some predetermined amount of time, and determines that the receipt is not valid for exit if the elapsed time is greater than the predetermined amount of time. The collation processing unit 102 transmits the result of the determination to the exit gate 8.

The image processing unit 103 executes processing for analyzing whether a shopping cart Q is included in the picked-up image from the image pickup unit 88 and that an object S is on the lower tier of the shopping cart Q in the image.

More specifically, the image processing unit 103 executes object detection processing on the picked-up image data received from the exit gate 8. For example, the image processing unit 103 analyzes the picked-up image data to identify whether the shopping cart Q is present in the image and, if the shopping cart Q is present, whether the object S is on the lower tier of the shopping cart Q. For the object detection processing, for example, a technique or algorithm such as “single shot multibox detector (SSD)” can be utilized.

If the image processing unit 103 finds that an object S is on the lower tier, the determination processing unit 104 may then execute processing for determining whether the object S is included in the stored transaction details that corresponds to the receipt ID (transaction ID) acquired by the reading processing unit 802.

More specifically, if the image processing unit 103 finds that object S is present on the lower tier of the shopping cart Q, the determination processing unit 104 checks whether the object S is a merchandise item that was purchased by the customer in the transaction associated with the receipt ID. To perform this determination, the determination processing unit 104 executes, for example, identification processing or object recognition processing. This processing is for identifying whether the particular object S is a merchandise item involved (already paid for) in the completed transaction. In the identification processing, the determination processing unit 104 may compare the feature data of the object S acquired via image pickup unit 88 with the feature or collation data of a merchandise item included in the transaction information 193. This comparison can be made, for example, based on the degree of similarity. For the identification processing, for example, a technique such as “EfficientNet” can be utilized.

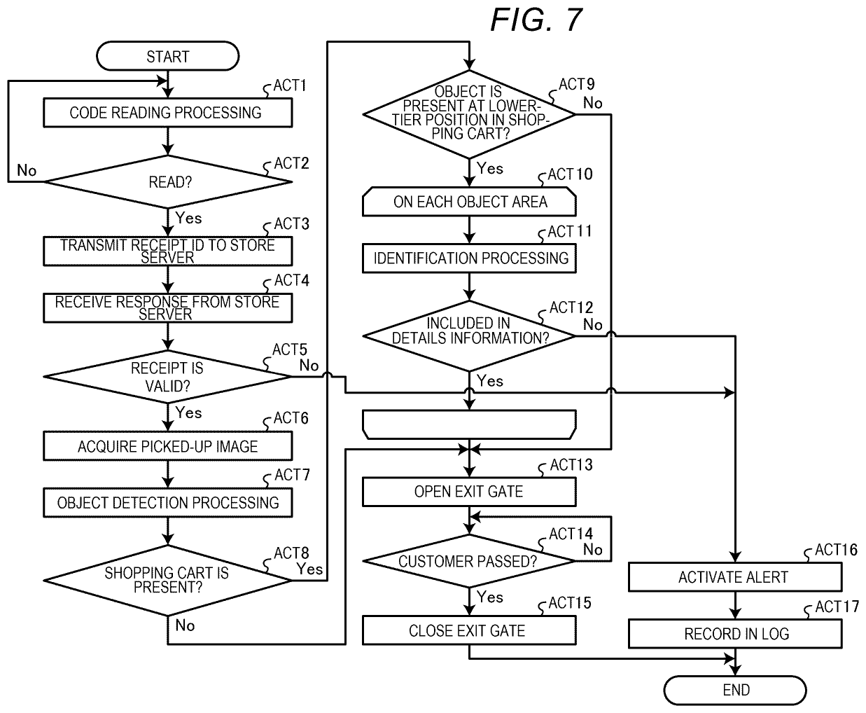

FIG. 7 is a flowchart showing processing executed by the control units 10, 80.

The control unit 80 of the exit gate 8 executes processing for reading a code symbol printed on a receipt via the code reader 87 (ACT 1). The control unit 80 repeats ACTS 1 to 2 (No in ACT 2) until the code reader 87 acquires a receipt ID in this process.

When the code reader 87 acquires a receipt ID (Yes in ACT 2), the control unit 80 transmits the receipt ID to the store server 1 (ACT 3) and then receives a response from the store server 1 (ACT 4). If the response from the store server 1 indicates that the receipt is valid (Yes in ACT 5), the control unit 80 acquires image data from the image pickup unit 88 and transmits the image data to the store server 1 (ACT 6).

The control unit 10 of the store server 1 executes object detection processing based on the received image data (ACT 7). If the shopping cart Q is present in the picked-up image (Yes in ACT 8) and the object S is present on the lower tier of the shopping cart Q (Yes in ACT 9), the control unit 10 executes loop processing of ACT 10 on each object area.

In the loop processing beginning at ACT 10, the control unit 10 first executes identification processing (ACT 11). The control unit 10 executes the identification processing by comparing the object S with the merchandise items included in the receipt. In this identification processing, the control unit 10 calculates the degree of similarity between the feature data of the object S and the feature data of merchandise items included in the transaction information 193. The control unit 10 then determines whether the object S is a merchandise item included in the details information (ACT 12). At this point, if the merchandise items included in the details information include a merchandise item with a degree of similarity to the object S that is higher than a predetermined threshold, the control unit 10 estimates that this merchandise item is the object S. That is, the control unit 10 determines that the object S is a merchandise item that has been purchased by the customer in the transaction (Yes in ACT 12).

If there are a plurality of objects S, the control unit 10 executes the processing of ACTS 11 to 12 on each object S, and only exits the loop processing of ACT 10 upon finishing the processing on all the objects S to advance to the processing of ACT 13.

In ACT 13, the control unit 10 transmits information giving an instruction to open to the exit gate 8 and hands over the processing to the exit gate 8. Upon receiving the information giving an instruction to open, the control unit 80 controls the motor 93 to open the door 86 and thus causes the exit gate 8 to be in an open state.

The control unit 80 then waits for the customer to pass (No in ACT 14). Once it is determined that the customer passed, based on the output from the image pickup unit 88 (Yes in ACT 14), the control unit 80 controls the motor 93 to move the door 86 to close the exit gate 8 (ACT 15), and this processing ends.

If the shopping cart Q is not included in the image (No in ACT 8), or if the shopping cart Q is present but the object S is not present on the lower tier of the shopping cart Q (No in ACT 9), the control unit 10 advances to ACT 13.

If the receipt which the customer presents to the code reader 87 to read is not valid (No in ACT 5), the control unit 80 advances to ACT 16 and causes the notification unit 92 to activate an alert (ACT 16). If an object S on the lower tier of the shopping cart Q is not included in the details information (No in ACT 12), the control unit 10 advances to ACT 16 and thus hands over the processing to the control unit 80 to activate an alert (ACT 16). Subsequently, the control unit 10 records information about the alert activation in a log (ACT 17) and this processing ends.

The monitoring system according to this first embodiment acquires an image of a region inside the exit gate 8, detects the shopping cart Q, determines whether an object S is present on the lower tier and, if so, is a merchandise item included in the details information, and activates an alert if an object S is not included in the details information. Thus, since the object S placed on the lower tier of the shopping cart Q may be a merchandise item yet to be settled/registered, a notification or alert to that effect can be given. Also, because the exit gate 8 is not opened, the customer in question can be kept inside the store and can be prevented from taking out the unregistered merchandise item(s).

In this way, according to the first embodiment, a monitoring system is provided that can prevent a merchandise item on the lower tier of a shopping cart from being taken out of the store without payment.

In some examples, the alert may be sent to a mobile terminal device carried by store staff, as well as to the store server. The alert thus provided may include the details which generated the alert.

While the object S is compared to the specific details information for the transaction in the above example, this is not limiting. For example, an alert may be activated if it is determined that the external appearance of the object S is likely not in any “category” (such as “contained in a cardboard box”, “rice bag”, or “a pack of multiple tissue boxes”) of any item registered in the transaction.

While the collation processing unit 102, the image processing unit 103, and the determination processing unit 104 are provided in the store server 1 in the first embodiment, this is not limiting and these units or the equivalents may be provided in another device (for example, the exit gate 8 or a sales data processing device such as the POS terminal 3).

Also, in practice, a configuration in which code symbols on a plurality of receipts can be read in ACTS 1 to 2 may be employed. With such a configuration, if the customer exits the store after a plurality of transactions, an object S can be compared with the details information for all the transactions of the customer and therefore trouble such as the activation of an alert despite that the object S is already being paid for can be avoided.

Moreover, in practice, the receipt ID and the image data outputted from the image pickup unit 88 may be collected and stored in association with each other in a predetermined memory unit. Thus, the circumstance under which an alert was activated can be checked or confirmed later.

The above embodiment can be implemented with various modifications. For example, by changing described configurations or functions of each of the above-described devices while still providing substantially similar processing results or outcomes. Additional modifications and examples will now be described as other embodiments. In the description below, primarily the differences from the already described examples will be described, and thus aspects that are the same as those already described will not necessarily be described further. The various embodiments and modification examples may be implemented separately or in a suitable combination.

### Second Embodiment

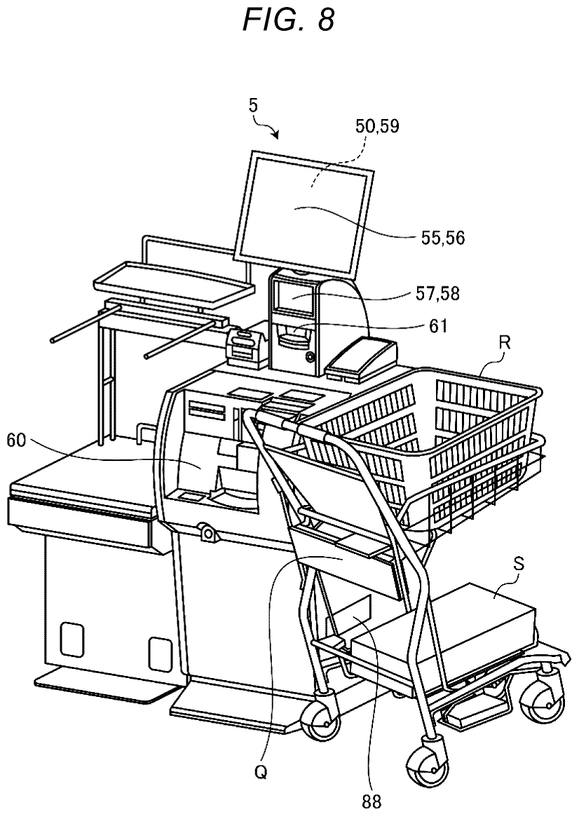

FIG. 8 illustrates the monitoring of the lower tier of a shopping cart Q at a full-self-service terminal 5 in a second embodiment.

The full-self-service terminal 5 includes display unit 55, an operation unit 56, a code reader 57 (e.g., a merchandise barcode scanner), an image pickup unit 58 (e.g., a camera), a deposit and withdrawal unit 60 (payment handling unit), and a receipt printer 61. These aspects are substantially similar to the display unit 35, the operation unit 36, the code reader 37, the image pickup unit 38, the deposit and withdrawal unit 40, and the receipt printer 41 provided in the POS terminal 3. The full-self-service terminal 5 also includes a control unit 50 and a memory unit 59, which are similar to the control unit 30 and the memory unit 39 of the POS terminal 3. The memory unit 59 stores the registration information 393 similarly to the memory unit 39. The full-self-service terminal 5 also includes an image pickup unit 88 that is similar to that provided in the exit gate 8 in the first embodiment. In full-self-service terminal 5, the image pickup unit 88 is at a lower part of the right side as depicted in FIG. 8.

In this second embodiment, the right side part of the full-self-service terminal 5 is designated as the position where the shopping cart Q is to be placed during operation of the full-self-service terminal 5. The image pickup unit 88 in the full-self-service terminal 5 is provided at a position where the image pickup unit 88 can image over a range where the lower tier of the shopping cart Q is located. Thus, if an object S is placed on the lower tier when the shopping cart Q is at its predetermined position, the image pickup unit 88 can acquire an image of the object S.

The control unit 50 of the full-self-service terminal 5 functions as the registration processing unit 301, the settlement processing unit 302, the image pickup processing unit 803, and the notification processing unit 805 described for the first embodiment. The notification processing unit 805 in this second embodiment uses, for example, the display unit 55 of the full-self-service terminal 5 as a notification unit, thus causes the display unit 55 displays or emit an alert.

In the second embodiment, when the customer finishes the registration processing and performs an operation to shift to the settlement processing, the control unit 50 of the full-self-service terminal 5 checks whether an object S is present on the lower tier of the shopping cart Q using the output from the image pickup unit 88. If it is determined that the object S is present, the control unit 50 executes identification processing and determines whether the object S is a merchandise item already registered in the registration information 393. If the object S is yet to be registered in the registration information 393, the control unit 50 activates an alert by displaying information on the display unit 55, or the like.

The details of the alert are given, for example, in the form of a text such as “Is there any merchandise item yet to be registered on the lower tier of the shopping cart?” For the activation of the alert, if the full-self-service terminal 5 is provided with a buzzer or a speaker, a sound may be output, and/or if the full-self-service terminal 5 is provided with an LED or a lamp, the LED or the lamp may be turned on.

After the activation of the alert, if an additional registration of a merchandise item is not performed or if the object S is not detected as removed from the lower tier of the shopping cart Q (e.g., based on the output from the image pickup unit 88) or the like, the control unit 50 may take further measures. In this context, further measures may include, for example, the execution of processing to call store staff, or the like.

In this way, according to the second embodiment, failure to register and pay for the object S on the lower tier of the shopping cart Q at the full-self-service terminal 5 can be prevented.

The program executed by each device in the above embodiments may be provided by being incorporated in a ROM or the like in advance. The program executed by each device in the above embodiments may be provided by being recorded as a file in an installable format or an executable format in a non-transitory, computer-readable recording medium such as a CD-ROM, a flexible disk (FD), a CD-R, or a digital versatile disk (DVD).

Also, the program executed by each device in the above embodiments may be stored on a computer connected to a network such as the internet and may be downloaded or accessed via the network. Also, the program executed by each device in the above embodiments may be provided or distributed via a network such as the internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, changes, and combinations in the form of the embodiments described herein may be made without departing from the spirit of the disclosure. The accompanying claims and their equivalents are intended to cover such forms or modifications as would fall within the scope and spirit of the disclosure.

What is claimed is:

1. A monitoring system, comprising:
an exit gate configured to open and close;
a sales data processing device configured to perform checkout processing of merchandise items in a sales transaction of a customer and generate a transaction receipt for the customer that can be read at the exit gate for exiting; and
a processor configured to:
acquire an identifier read from the transaction receipt at the exit gate;
receive an image of a lower tier of a shopping cart at the exit gate and identify whether an object is on the lower tier;
determine whether a merchandise item corresponding to the object on the lower tier was included in a sales transaction associated with the acquired identifier when the object is identified as being on the lower tier; and
open the exit gate when it is determined that the object on the lower tier corresponds to a merchandise item included in the sales transaction associated with the acquired identifier, and otherwise keep the exit gate closed when the object is on the lower tier.

2. The monitoring system according to claim 1, wherein the processor is further configured to cause an alert to be output when it is determined that the object on the lower tier does not correspond to a merchandise item included in the sales transaction associated with the acquired identifier.

3. The monitoring system according to claim 2, wherein the alert is output as a visual alert at the exit gate.

4. The monitoring system according to claim 2, wherein the alert is output as an audio alert at the exit gate.

5. The monitoring system according to claim 1, wherein the processor is in a store server.

6. The monitoring system according to claim 1, wherein the processor is configured to identify whether the object is on the lower tier using object detection processing.

7. The monitoring system according to claim 6, wherein the object detection processing includes a single shot multibox detector algorithm.

8. The monitoring system according to claim 1, wherein
the exit gate includes:
a pair of sidewalls forming an exit passage; and
a camera in one sidewall of the pair of sidewalls, and
the image of the lower tier of the shopping cart is provided by the camera.

9. A point-of-sale terminal, comprising:
a display screen;
a merchandise registration unit;
a payment handling unit;
an image pickup unit positioned to image a lower tier of a shopping cart at the point-of-sale terminal; and
a control unit configured to:
execute registration processing on merchandise items to be purchased by a customer based on items presented to the merchandise registration unit;
execute settlement processing on merchandise items registered in the registration processing based on a settlement method presented by the customer to the payment processing unit;
receive an image from the image pickup unit and determine whether an item is on the lower tier of the shopping cart; and
if the item is determined to be on the lower tier check whether the item corresponds to a merchandise item registered in the registration processing before shifting from the registration processing to the settlement processing.

10. The point-of-sale terminal according to claim 9, wherein the control unit is further configured to:
output an alert when the item is determined to be on the lower tier and does not correspond a merchandise item registered in the registration processing.

11. The point-of-sale terminal according to claim 10, wherein the alert is output as a visual alert.

12. The point-of-sale terminal according to claim 10, wherein the alert is output as an audio alert.

13. The point-of-sale terminal according to claim 9, wherein the control unit is configured to identify whether the item is on the lower tier using object detection processing.

14. The point-of-sale terminal according to claim 13, wherein the object detection processing includes a single shot multibox detector algorithm.

15. A sales data processing method for a sales data processing device, the method comprising:
executing registration processing on merchandise items to be purchased by a customer at a sales data processing device based on items presented to a merchandise registration unit of the sales data processing device;
execute settlement processing on merchandise items registered in the registration processing based on a settlement method presented by the customer to a payment processing unit of the sales data processing device;
receive an image from an image pickup unit of the sales data processing unit and determine whether an item is on a lower tier of a shopping cart at the sales data processing unit; and
if the item is determined to be on the lower tier check whether the item corresponds to a merchandise item registered in the registration processing before shifting from the registration processing to the settlement processing.

16. The method according to claim 15, further comprising:
outputting an alert when the item is determined to be on the lower tier and does not correspond a merchandise item registered in the registration processing.

17. The method according to claim 16, wherein the alert is output as a visual alert.

18. The method according to claim 16, wherein the alert is output as an audio alert.

19. The method according to claim 15, wherein the determination of whether the item is on the lower tier is made using object detection processing.

20. The method according to claim 19, wherein the object detection processing includes a single shot multibox detector algorithm.
